(19) United States
(12) Patent Application Publication
(10) Pub. No.: US 2002/0053269 A1
(43) Pub. Date: May 9, 2002

(54) Procedure for the production of a bar notch in the side of a side member and a bar notch at the end of a cross member for a bar joint between a side member and a cross member, and a machine for the implementation of the procedure

(76) Inventor: Agner Pedersen, Langa (DK)

Correspondence Address: DENNISON, MESEROLE, SCHEINER & SCHULTZ, Suite 612, 1745 Jefferson Davis Highway, Arlington, VA, 22202-3417, US

(21) Appl. No.: 09/756,733

(22) Filed: Jan. 10, 2001

(30) Foreign Application Priority Data
Nov. 7, 2000 (DK) PA 2000 01661

(51) Int. Cl. B26D 3/10

(52) U.S. Cl. 83/13; 83/829; 83/917

(57) ABSTRACT

A bar notch (3) in the side of a side member (1) and a shaping cut (4) at the end of a cross member (2) for the bar jointing of a side member (1) with a member (2) in workpieces of wood, plastics or MDF—medium density fibreboard—produced by a punching or shearing operation consisting of a first step—a preliminary cut—and a second step—a final cut. A machine for implementation of the cutting operation comprises a knife head (9) for two side knives (10) and a nose knife (11), a table (14) and a rest (13), a first set of adjustable guide members (17) that can set the position of the knife head (9) in relation to the workpiece (1) or (2) which is to be processed, a second set of adjustable guide members (23) for setting of the mutual distance between the cross member notches (3), and a third guide members (29), which can serve as an end stop for the end of the cross member (2) during the shearing process of a cross member shaping (4). Under the knives (10, 10, 11) the table (14) has an embedded dolly (34) of a soft material. The procedure is faster and less cumbersome than procedures used so far, where the cuts are produced by milling with rotating tools, which are difficult to adjust.

Procedure for the production of a bar notch in the side of a side member and a bar notch at the end of a cross member for a bar joint between a side member and a cross member, and a machine for the implementation of the procedure.

The present invention relates to a procedure for the production of a bar notch in a side member and a cross member notch at the end of a cross member in connections with notched joints of the kind mentioned in the pre-characterising part of claim 1.

Up to now such notches have been produced by milling with a rotating tool. This procedure is slow and cumbersome, as the tool is difficult to adjust. Furthermore, machines with rotating tools are complicated in their construction and therefore expensive to produce.

It is the purpose of the present invention to describe a procedure for the production of cross member notches and side member notches by means of which the said drawbacks can be avoided.

This is achieved by the procedure described in the characterising part of claim 1.

The invention also comprises a machine for the implementation of the procedure according to the invention.

Such a machine is described in claim 2.

Claim 3 deals with a first set of adjustable guide members for a machine according to the invention.

Claim 4 deals with a second set of adjustable guide members for a machine according to the invention.

Claim 5 describes a preferred embodiment of a stop for the second set of adjustable guide members.

Claim 6 describes a third guide members for a machine according to the invention.

Claim 7 describes a preferred method of mounting of a dolly for a machine according to the invention.

Claim 8 describes how to produce a notch for a cross member by a simple punching or shearing operation.

The invention is explained in detail below with reference to the drawing in which

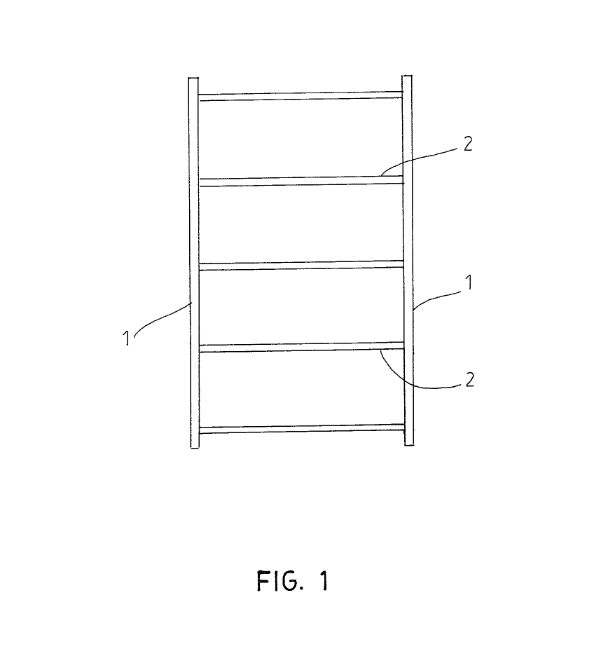

FIG. 1 is a schematic section of a frame made of two side members and a number of cross members,

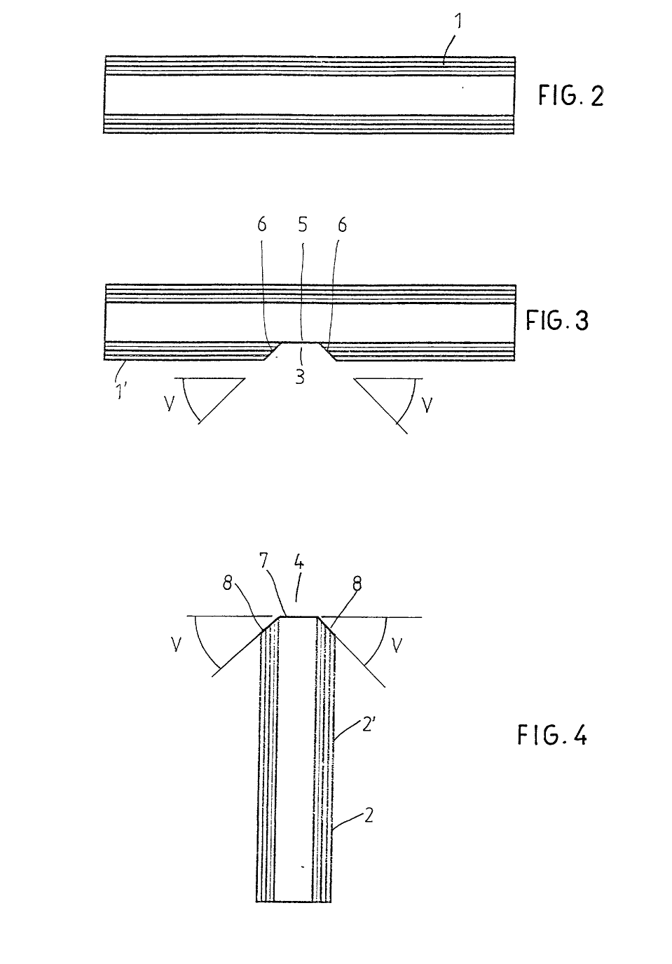

FIG. 2 is a top view of a section of a side member for a frame,

FIG. 3 is an illustration of the side member corresponding to the one in FIG. 2 with a bar notch,

FIG. 4 is a top view of a section of a cross member with a cross member notch,

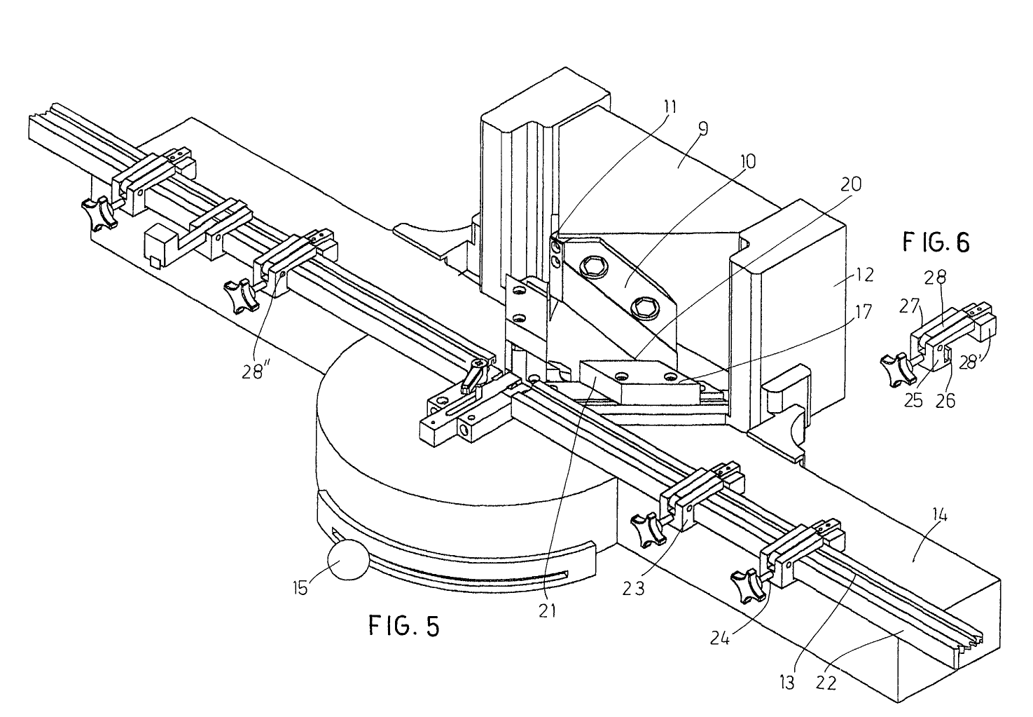

FIG. 5 is a perspective view of part of a machine for the implementation of the procedure according to the invention,

FIG. 6 shows a stop for a machine for the implementation of the procedure according to the invention,

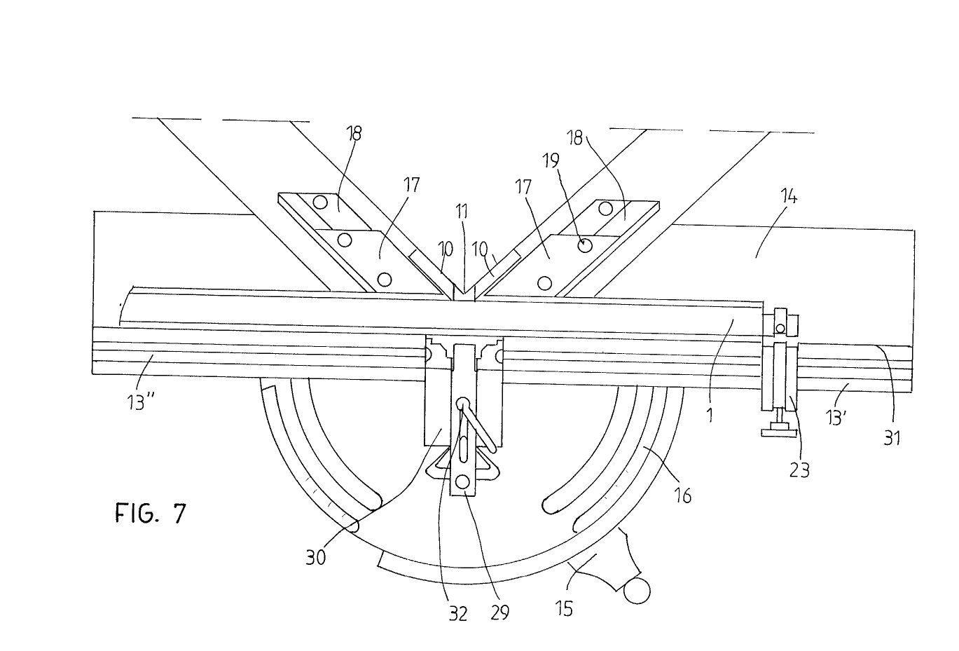

FIG. 7 is a top view of part of a machine for the implementation of the procedure according to the invention with a side member in position and the knife head moved forward during the shearing of a cross member notch,

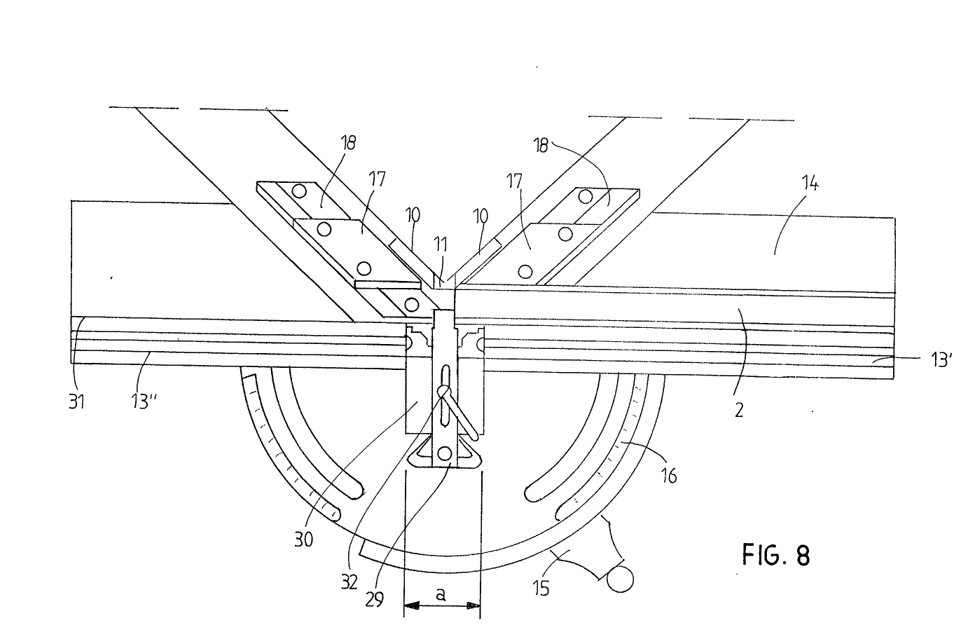

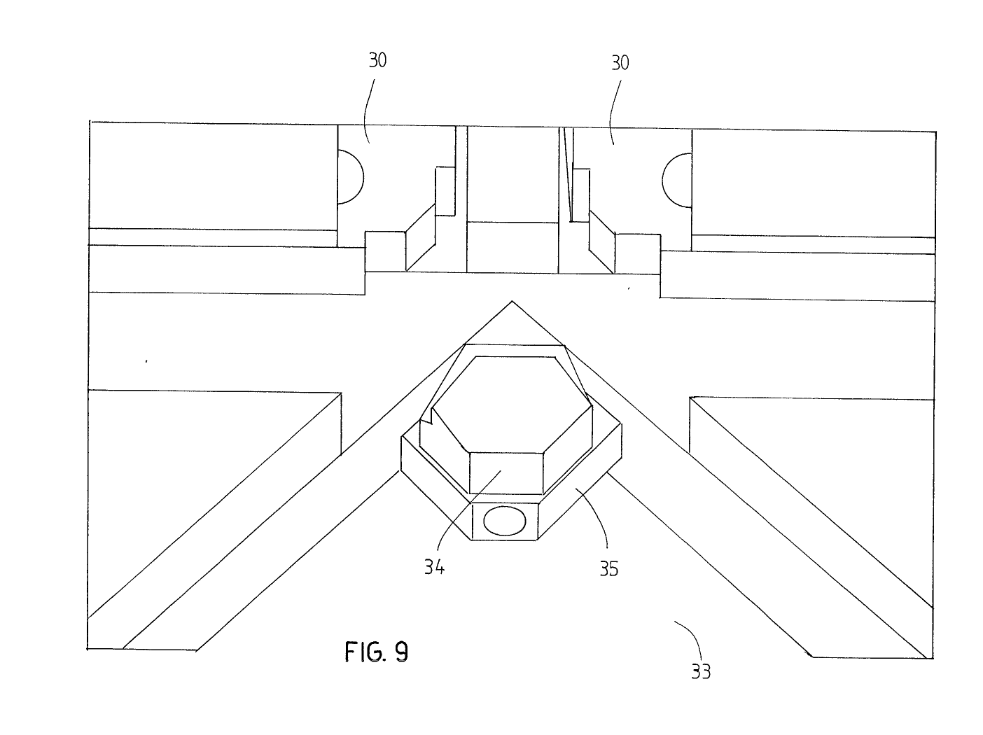

FIG. 8 is a top view of part of a machine for the implementation of the procedure according to the invention with a cross member in position during the shearing operation of a cross member notch,

FIG. 9 is a perspective view of part of a machine for the implementation of the procedure according to the invention with the knife head removed,

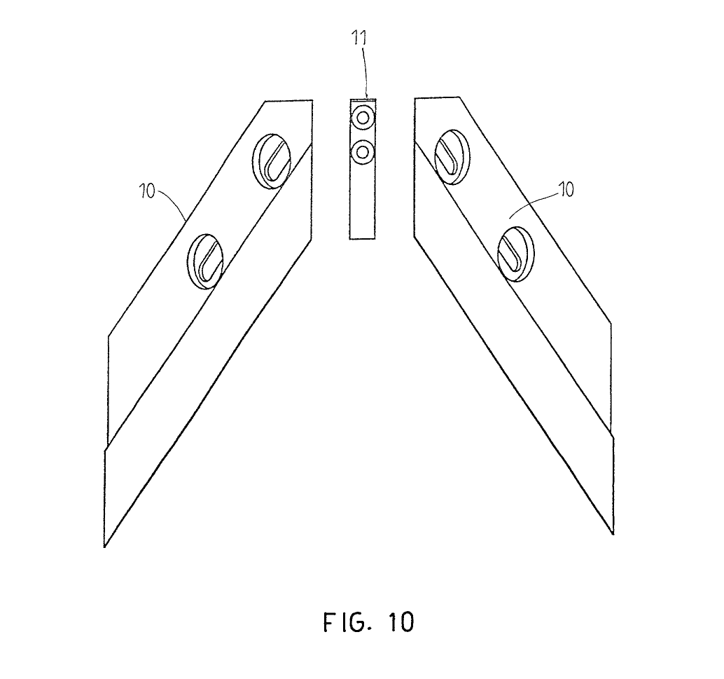

FIG. 10 is a perspective view of two side knives and a nose knife for a machine for the implementation of the procedure according to the invention

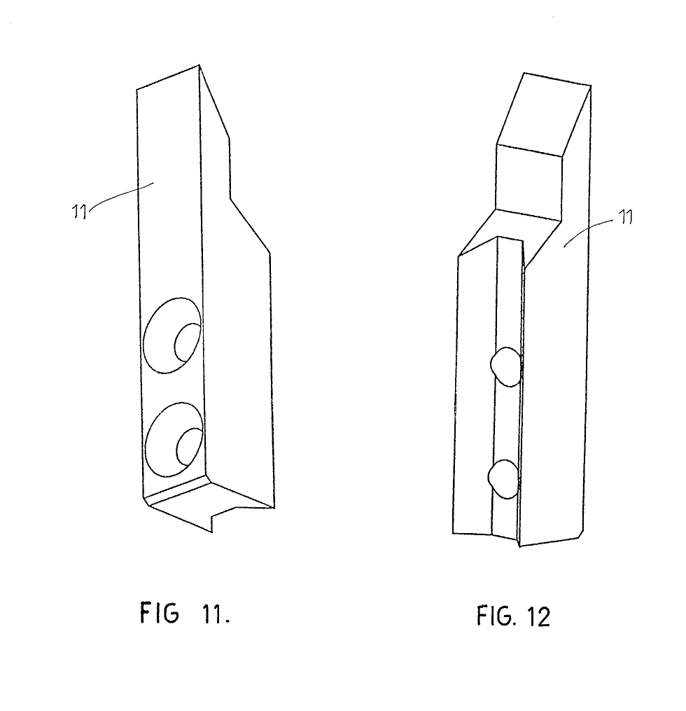

FIG. 11 is a perspective view of a nose knife, for a machine for the implementation of the procedure according to the invention, and

FIG. 12 shows the nose knife from another angle.

As shown in FIG. 1 a frame, for example for doors or gates, consists of two side members 1 and of a number of cross members 2. The side members 1 and the cross members 2 are joined in bar joints consisting of a bar notch into the side of a side member 1 and a cross member notch 4 at the end of a cross member 2. A side member notch can have a plane bottom 5, which is parallel with a side surface 1′ of the side member 1 and two oblique sides 6, which are of equal length and which have two equally large oppositely directed inclines v in relation to the bottom 5. A cross member notch 4 consists of a plane end piece 7 at right angles to a side surface 2′ in the member 2, and of two equally long oblique sides 8, which have two identical oppositely directed inclines v in relation to the bottom 7. The bottom 7 and the sides 8 are of such a length that the shape of the cross member fits into the notch.

According to the invention a side member notch 3 and a cross member notch 4 are produced in one punching or shearing operation.

As shown in the drawing, FIGS. 5-10, a machine for the production of side member and cross member cuts by shearing comprises a triangular knife head 9—viewed from above—for two side knives 10 and a nose knife 11. The knife head 9 is movable in the vertical direction in a guide 12. This movement can be effected, for example, by means of of a not shown foot pedal, but it can also be done automatically, for example hydraulically. The guide 12 is movable in the horizontal direction towards or away from a workpiece to be worked and which rests against a rest 13 on a table 14. This movement can be effected by activation of a handle 15 on a not shown arm, and the setting can be read on a scale 16. This movement can also be automatic, for example hydraulic.

As shown the machine comprises a first set of adjustable guide members which can set the position of the knife head 9 in relation to the workpiece 1 or 2, which is to be processed, accurately during the shearing operation.

These guide members can consist of two stops 17, which each are displaceably mounted on a guide rail 18, which is mounted on the knife head 9, each along its own side knife 10 and parallel with them. The stops 17 have an inside edge 20, which in its mounted position rests against the outside of the side knives 10 and a plane front side 21, which is parallel with the rest 13 and can come to rest against the workpiece 1 or 2, which is to be processed.

The machine also comprises a second set of of adjustable guide members for the setting of the distance between the bar notches, which are sheared into the side of a side member 1.

As shown in the drawing the rest 13 is embodied as a guide rail with a vertical, longitudinal guide list 22 at the rear end. The second set of guide members consists of a number of stops 23, which are displaceable along the rest 13 and can be clamped to it by a knob-head bench screw 24. Each stop 23 has at its rear end—at the guide list 22—an lower part 25 with a U-shaped opening 26, which can accommodate the lower edge of the guide list 22, and an upper part 27, which is embodied as a fork, which in its mounted position reaches in over the whole width of the rest 13. An arm 28, which can be received in the fork 27, is at one end embodied with a stop 28′ against which the end of a workpiece 1, which is to be processed, can come to rest. At the opposite end the arm 28 is swingably hinged to the upper part 27 by a pin 28″, so that it can be swung over to a passive position.

As shown in FIGS. 7 and 8 the rest 13 is split up into a right-hand part 13′ and a left-hand part 13″, which off the centre of the knife head 9 are placed at a mutual distance a. The third guide members consists of a catch 29, which can be moved crosswise to the rest 13 in a guide 30, which is mounted on the table 14 in the space a. As shown the catch 29 can be displaced to adopt a forward working position in which it protrudes a distance forward over the front edge 31 of the rest 13, and in which it serves as a rest for the end of a cross member 2 during the punching of a cross member notch 4. From this position the catch 29 can be displaced to a retracted, passive position behind the front edge of the rest. The catch can be fixed to the table 14 by means of a clamping arrangement 32.

As shown in FIG. 9 there is a indentation 33 in the table 14 under the set of knives 10, 10, 11. The cutting edge of the side knives 10 and the nose knife 11 can therefore in their bottom position be at a level with or slightly lower than the top side of the table 14. In the indentation 33 there is a detachably mounted dolly 34 of a soft material, e.g. of a synthetic material. The dolly 34 can be supported by and mounted on a plate member 35 screwed to the machine. The result is that a clean cut can be produced in the workpiece to be processed.

The nose knife 11 can be of the same width as the bottom 5 in a cross member notch 3. Consequently, there is no need to displace the bar 1 lengthwise along the rest 13 during the shearing of a cross member notch 3.

The nose knife shown in FIGS. 11 and 12 with a V-shaped notch is employed for narrow workpieces.

When a shearing operation is started the plane front side 21 of the guide organs 17 is held at a short distance from the side of the bar to be processed. In the final phase of the shearing operation the front side 21 rests against the side of the workpiece 1 or 2.

1. Procedure for the production of a bar notch (3) in the side of a side member (1) and of a cross member notch (4) on the end of a cross member (2) at the joint between a side member (1) and a cross member (2) in workpieces of wood, plastics or MDF—medium density fibreboard—where the cross member notch preferably has a plane bottom (5), which is parallel with a side surface (1′) in the side member and two equally long, oblique sides (6), which have oppositely directed equal inclinations in relation to the bottom (5), and where the cross member notch has a plane end (7) in a cross member (2) and two inclined sides (8), which are of a shape and size such as to make the shaped cross member end (4) fit into the notch (3), characterised by the fact that
the side member notch (3) and the cross member shaped end (4) are produced by a punching or shearing operation, and that at least the side member notch is preferably produced in a first step—a preliminary shear—and a second step—a final shear or a finishing shearing.

2. Machine for implementation of the procedure according to claim 1, which comprises in top-view a triangular knife head (9) for two side knives (10) and a nose knife (11), which is displaceable in the vertical direction in a guide (12), which can be moved in the horizontal direction towards or away from a workpiece, which is to be processed, and rests against a rest (13) on a table (14), characterised by the fact that
the machine is embodied with a first set of adjustable guide members (17), which can adjust the position of the knife head (9) in relation to the workpiece (1) or (2), which is to be processed, exclusively during the shearing operation, with a second set of adjustable guide members (23) for setting of the distance between the bar notches (3), and with a third guide members (29), which can function as an end stop for a cross member in the process of shearing a cross bar notch (4), and that the table (14) is embodied with an indentation (33) which permits the bottom cutting edge of the two side knives (10) and the nose knife (11) in their bottom position to be level with or slightly lower in relation to the top side of the table (14), and that the indentation (33) is fitted with a dolly (34) of a soft material, for example a synthetic material.

3. Machine according to claim 2. characterised by the fact that
the first set of adjustable guide members consists of two stops (17) which each is displaceably positioned on a guide rail (18) mounted on the knife head (9) each along its own side knife (10) and which can be fixed to a guide rail (18) in a desired position by means of screws (19) which stops (17) have an internal edge (20), which rests against the outer side of a side knife (10) and a plane front side (21), which can come to rest against the workpiece (1) or (2) which is to be processed, and which is parallel with the rest (13).

4. Machine according to claim 2 characterised by the fact that
the rest (13) is embodied as a guide rail with a longitudinal guide list (22) at the rear end, and that the second set of adjustable guide members consists of a number of stops (23), which can be displaced in the longitudinal direction of the rest (13) and can be fixed to it in a desired position by means of a bench screw (24) with a handle, and that the stop (23) is embodied with a swingable arm (28), which from an active position—in which a stop (28′) at the end of the arm can come to rest against the end of the workpiece (1) to be processed can be swung to a passive position.

5. Machine according to claim 4 characterised by the fact that
the stop (23) at the rear end at the guide list (22) has a lower part (25) with a U-shaped opening (26) to accommodate the bottom edge of the guide list (22), and an upper part (27) embodied as a fork, which in its mounted position reaches in over the rest (13) and acts as a guide for the arm (28) in the latter's active position, and that the arm (28) is swingably hinged to the upper part (27) at a stud (28″).

6. Machine according to claim 2 characterised by the fact that
the rest (13) consists of two parts, a right-hand part (13′) and a left-hand part (13″), which off the centre of the knife head (9) are placed at a mutual distance (a), and that the third guide members consists of a catch (29), which can be made of square-bar steel and which can be displaced crosswise to the rest (13) in a guide (30) which is mounted on the table (14) in the space (a) from a forward processing position in which the catch (29) projects a distance forward of the front edge (31) of the rest (13), and where it serves as a rest for the end of a bar (2) during the punching of a cross member notch (4), to a retracted passive position, and that the catch (29) can be fixed to the table (14) by means of a clamping arrangement (32).

7. Machine according to claim 2 characterised by the fact that
the dolly (34) is detachably mounted on a plate (35).

8. Machine according to claim 2 characterised by the fact that
the nose knife (11) is of the same width as the bottom (5) in a side member notch (3).
